(19) United States
(12) Patent Application Publication
(10) Pub. No.: US 2002/0140837 A1
(43) Pub. Date: Oct. 3, 2002

(54) Imaging device

(75) Inventors: Hiroyuki Miyake, Chiyoda-ku (JP); Noriyuki Komori, Chiyoda-ku (JP); Takashi Shirase, Chiyoda-ku (JP); Ryujiro Hiroe, Chiyoda-ku (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: MITSUBISHI DENKI KABUSHIKI KAISHA, Chiyoda-ku (JP)

(21) Appl. No.: 10/106,253

(22) Filed: Mar. 27, 2002

(30) Foreign Application Priority Data
Mar. 30, 2001 (JP) 2001-098799

(51) Int. Cl. H04N 5/225

(52) U.S. Cl. 348/340

(57) ABSTRACT

An imaging device comprising an imaging element having a light acceptance plane, a frame surrounding a marginal portion of said imaging element and fixing said imaging element, an image formation lens configured to form an image on said light acceptance plane, a lens-barrel configured to support said image formation lens, and a supporting member on which said lens-barrel is mounted and including legs forming an opening for accommodating said frame and said imaging element, wherein an outside of said frame includes protrusions, the legs of said supporting member include mount portions configured to mount said protrusions, and said protrusions are mounted integrally on said mount portions.

### CROSS-REFERENCE TO A RELATED DEVICE

The present patent application is related to Attorney Docket No. 220019US-2 filed on Mar. 27, 2002, by the Applicant (corresponding to the Japanese Patent Application No. 2001-093815 filed on Mar. 28, 2001).

### BACKGROUND OF THE INVENTION

### FIELD OF THE INVENTION

The present invention relates to an imaging device used in electronic devices such as cellular phones, hand-held terminals, personal computers, video cameras, scanners, etc.

### DISCUSSION OF THE PREFERRED EMBODIMENTS

Imaging devices are now widely used in hand-held terminals, cellular phones and the like. These imaging devices are increasingly required to be smaller in size, and various technological developments have been attempted to reduce the size of the devices.

For example, Japanese Patent Publication (unexamined) No. 191864/1999 discloses a solid-state imaging device. In this solid-state imaging device, a CCD (charge coupled device) chip is mounted on one side of a circuit board (substrate) provided with conductive printed wiring. Further, an opening is formed on the circuit board at a place facing an effective picture element region of the CCD chip, and an imaging plane of the CCD chip is located in such a manner as to face the opening formed on the circuit board.

The mentioned Japanese Patent Publication also discloses that the opening on the circuit board is directed toward an imaging lens to shorten the distance between the imaging lens and the CCD chip.

In the above-mentioned conventional imaging device, it is certainly possible to shorten the distance between the imaging lens and the CCD chip, thereby reducing the size of the imaging device in that direction. However, a problem exists with the conventional imaging device. That is, if the CCD chip is not positioned accurately with respect to the imaging lens, an effective image circle of the imaging lens is away from the effective picture element region of the CCD chip. Consequently, a higher portion of the image (i.e., an outermost portion of the image) is not formed on the effective picture element region of the CCD chip, and it is not possible to obtain a quality image.

Particularly, when using a sheet circuit board (a film-like circuit board) such as FPC (flexible printed circuit), it is very difficult to secure the desired positioning accuracy described above because the circuit board itself is thin and soft.

### SUMMARY OF THE INVENTION

Accordingly, one object of the present invention is to solve the above-noted and other problems.

Another object of the present invention is to provide a novel imaging device in which a positioning accuracy of an imaging element with respect to an imaging lens can be secured by forming a frame surrounding the imaging element on a leg portion of the imaging lens, thereby obtaining a quality image and a compact imaging device.

To achieve these and other objects, the present invention provides a novel imaging device including an imaging element having a light acceptance plane, a frame surrounding a marginal portion of the imaging element and fixing the imaging element, and an image formation lens for forming an image on the light acceptance plane. Also included is a lens-barrel for supporting the image formation lens, and a supporting member on which the lens-barrel is mounted and including legs forming an opening for accommodating the frame and the imaging element. Further, protrusions are provided on an outside of the frame, mount portions for mounting the protrusions are provided on the legs of the supporting member, and the protrusions are mounted integrally on the mount portions.

As a result, it is possible to accurately mount the imaging element on the opening surrounded with the legs, reduce the size the imaging device, and achieve automatic assembling of the imaging device.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view showing an imaging device according to Embodiment 1 of the present invention;

FIGS. 2(a), (b) and (c) are perspective views illustrating steps in constructing the imaging device according to Embodiment 1 of the present invention;

FIG. 3 is a perspective view similar to FIG. 1 in which a line I-I is added;

FIG. 4 is a sectional view of the imaging device taken along the line I-I in FIG. 3;

FIG. 5 is a perspective view showing an imaging device according to Embodiment 2 of the present invention;

FIG. 6 is an exploded perspective view showing the imaging device according to Embodiment 2 of the present invention;

FIG. 7 is a perspective view similar to FIG. 5 in which a line II-II is added;

FIG. 8 is a sectional view of the imaging device taken along the line II-II in FIG. 7;

FIG. 9 is a perspective view showing an imaging device according to Embodiment 3 of the present invention;

FIG. 10 is an exploded perspective view showing the imaging device according to Embodiment 3 of the present invention;

FIG. 11 is a perspective view showing a supporting member of an imaging device according to Embodiment 4 of the present invention;

FIG. 12 is a perspective view showing a modification of the supporting member of the imaging device according to Embodiment 4 of the present invention;

FIG. 13 is a schematic perspective view showing a state of applying a liquid fixing member in an imaging device according to Embodiment 5 of the present invention;

FIG. 14 is a schematic perspective view showing a state of applying a film-like fixing member in the imaging device according to Embodiment 5 of the present invention;

FIG. 15 is an exploded perspective view showing the imaging device according to Embodiment 5 of the present invention in which a line III-III added;

FIG. 16 is a sectional view of the imaging device taken along the line III-III in FIG. 15;

FIG. 17 is a sectional view showing an opening of the imaging device shown in FIG. 16 sealed with a sealing member;

FIG. 18 is a sectional view showing of an imaging device according to Embodiment 6 of the present invention;

FIG. 19 is a sectional view showing an opening of the imaging device shown in FIG. 18 sealed with a sealing member;

FIG. 20 is a perspective view showing an imaging device according to Embodiment 7 of the present invention;

FIG. 21 is an exploded perspective view showing the imaging device according to Embodiment 7 of the present invention;

FIGS. 22(a) and (b) are perspective views illustrating steps in constructing the imaging device shown in FIG. 21.

FIG. 23 is an exploded perspective view showing the imaging device according to Embodiment 8 of the present invention in which a line IV-IV is added;

FIG. 24 is a sectional view of the imaging device taken along the line IV-IV in FIG. 23;

FIG. 25 is a sectional view for explaining the imaging device according to Embodiment 8 of the present invention; and

FIG. 26 is a perspective view showing the imaging device according to Embodiment 8 of the present invention.

### DESCRIPTION OF THE PREFERRED EMBODIMENTS

Several preferred embodiments of the invention are hereinafter described with reference to the accompanying drawings. In the drawings, the same reference numerals are designated to the same or like parts.

### EMBODIMENT 1

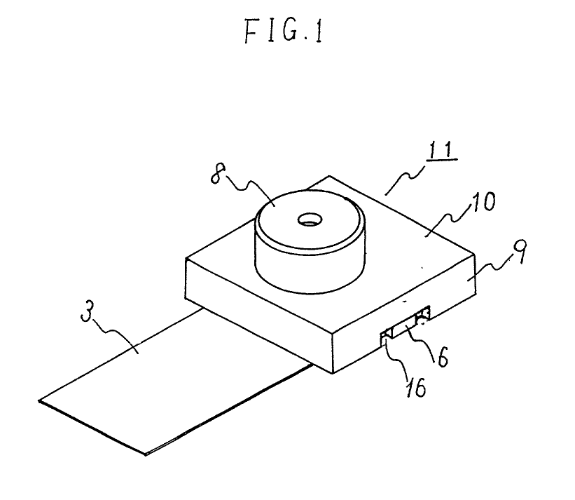

Embodiment 1 of the invention is hereinafter described with reference to FIGS. 1 to 4.

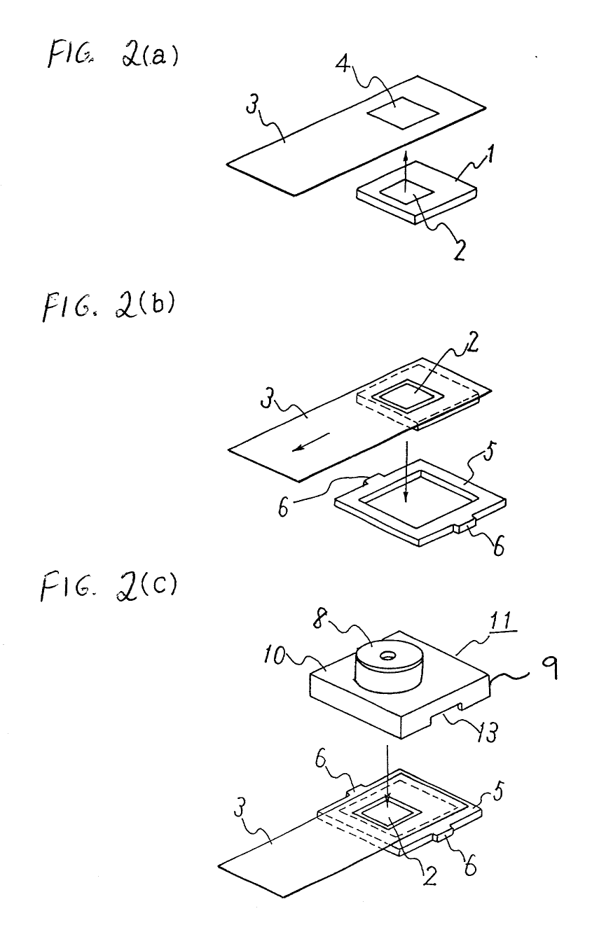

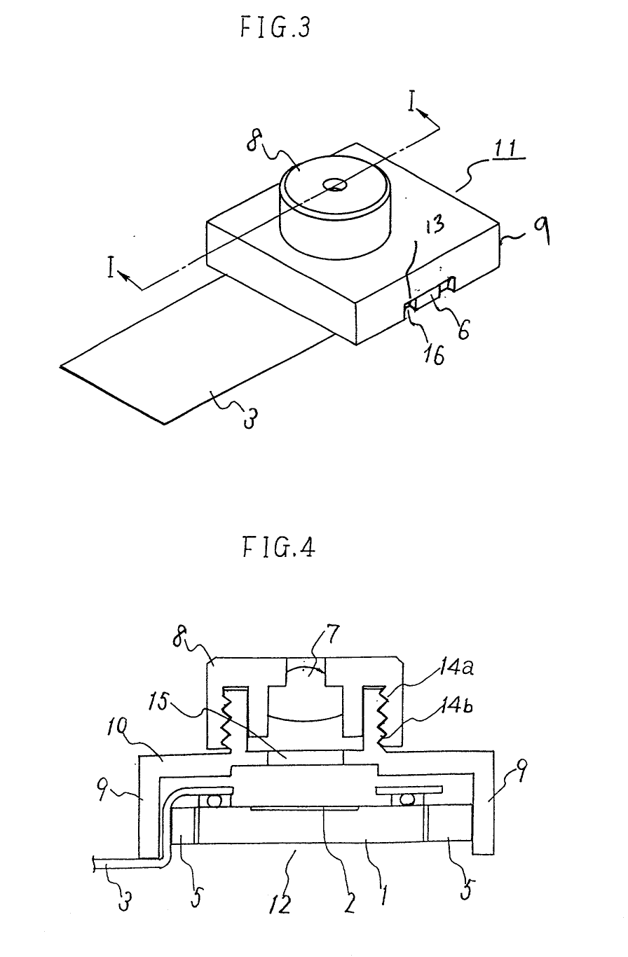

FIG. 1 is a perspective view showing an imaging device according to Embodiment 1 of the invention, and FIGS. 2(a) to (c) are perspective views showing steps in constructing the imaging device according to Embodiment 1. Further, FIG. 3 is a perspective view similar to FIG. 1 and in which a line I-I is added, and FIG. 4 is a sectional view of the imaging device taken along the line I-I in FIG. 3.

Shown in FIGS. 1 to 4 is an imaging element 11 such as CCD chip, an imaging plane 2 (it is also referred to as a light acceptance plane) of the imaging element 1, and a film-like circuit board 3 (hereinafter simply referred to as “the circuit board”) composed of FPC or the like. In addition, a through-hole 4 where the imaging plane 2 is exposed is formed near the end of the circuit board 3. A wiring pattern (not shown) is also formed on one face or both faces of the circuit board 3.

As shown in FIG. 2(b), the imaging element 1 is fixed to the backside of the circuit board 3 so the imaging plane 2 corresponds to the through hole 4 and is exposed from an upper portion of the circuit board 3. Further, a frame 5 surrounds the imaging element 1, and is fixed to the imaging element 1 so as to surround a peripheral side of the imaging element 1 as shown in FIG. 2(c).

Also shown are protrusions 6 integrally formed with the frame 5. The protrusions 6 are formed on the sides in the width direction of the circuit board 3 and protrude respectively in the direction perpendicularly crossing the extending direction of the circuit board 3 indicated by the arrow in FIG. 2(c). An imaging lens 7 (also referred to as image formation lens) is also shown (see FIG. 4) and forms an image on the imaging plane 2 through the through-hole 4 of the circuit board 3. A lens-barrel 8 holds the imaging lens 7, and a supporting portion 10 connects the lens-barrel 8 with a leg portion 9. The lens-barrel 8, the leg portion 9 and the supporting portion 10 form a supporting member 11.

As shown in FIG. 2(c), the leg portion 9 includes recesses (cutout parts) 13 where the protrusions 6 are inserted and fitted. FIG. 3 shows the protrusions 6 of the frame 5 fitted in the recesses 13 of the leg portion 9.

As shown in FIG. 4, the leg portion 9 and the supporting portion 10 form an opening 12 which is a box-shaped space, and the imaging element 1 and the circuit board 3 combined with the frame 5 are inserted into the opening 12.

The frame 5 and the supporting member 11 can be formed with a high dimensional accuracy by injection molding of ABS resin or the like. In such a molding, the protrusions 6 of the frame 5, the recesses (cutout parts) 13 of the leg 9, and a later-described focal distance adjusting mechanism including the lens-barrel 8 and the supporting portion 10 can be easily formed.

Further, the imaging lens 7 held by the lens-barrel 8 and the imaging element 1 can be easily positioned by fitting the protrusions 6 of the frame 5 formed with high dimensional accuracy into the recesses 13 of the leg portion 9. Consequently, an image is correctly formed on the imaging plane 2 of the imaging element 1 through the imaging lens 7.

As shown in FIG. 4, an inner screw groove is formed inside the lens-barrel 8, and another screw groove that fits with the inner screw groove is formed on the supporting portion 10 (hereinafter referred to as a screw-fitting mechanism 14a). Furthermore, the lens-barrel 8 is provided with a guide portion 14b inside the screw fitting mechanism 14a forming a double structure.

With the screw fitting mechanism 14a, the lens-barrel 8 is constructed so a focal distance in the direction of height of the imaging lens 7 with respect to the imaging plane 2 is adjustable. Further by combining, fitting and assembling the guide portion 14b and the supporting portion 10 together, the relative position between an optical axis of the image formation lens 7 and the imaging plane 2 is established within a predetermined tolerance.

In addition, the supporting portion 10 includes a hole 15 for passing light to form an image through the imaging lens 7 above the imaging plane 2. Further, strict dimensional tolerances are required to secure the protrusions 6 of the frame 5 and the recesses 13 of the leg portion 9 by simply snapping the protrusions 6 and the recesses 13 together. Accordingly, it is preferable to expand the allowable range of this tolerance and fix the protrusions 6 of the frame 5 to the recesses 13 of the leg portion 9 by a fixing mechanism 16 such as an adhesive. The device may be fitted using both of these arrangements.

### EMBODIMENT 2

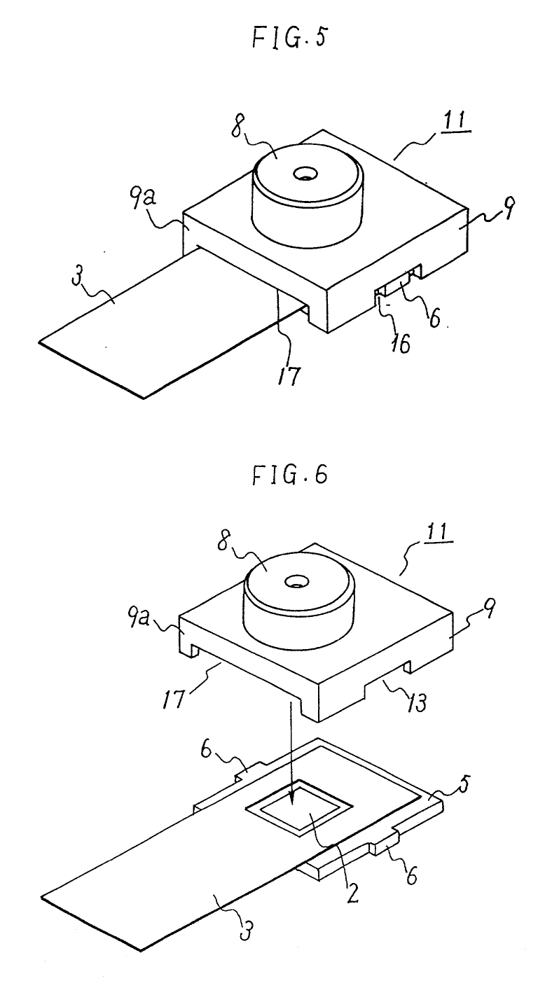

Embodiment 2 of the invention will now be described with reference to FIGS. 5 to 8.

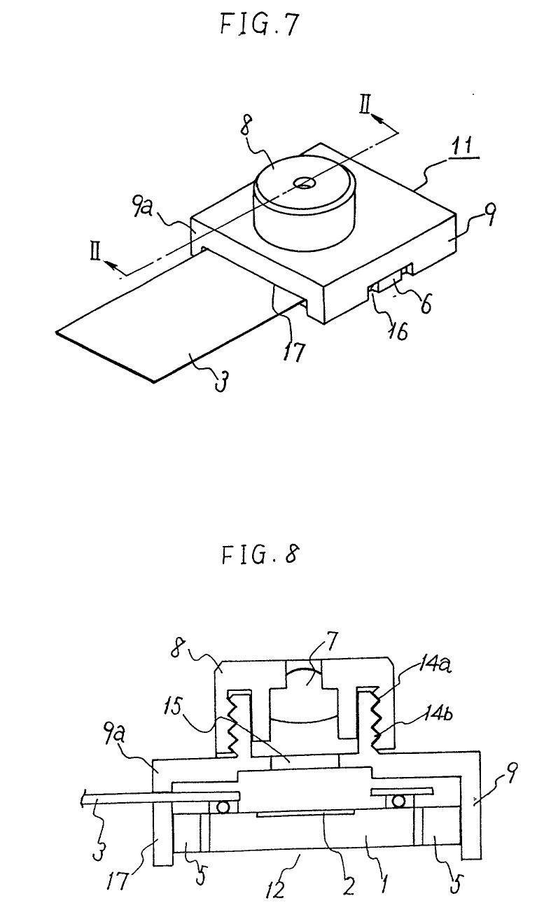

FIG. 5 is a perspective view showing an imaging device according to Embodiment 2, and FIG. 6 is an exploded perspective view of the imaging device according to Embodiment 2. Further, FIG. 7 is a perspective view similar to FIG. 5 in which a line II-II is added, and FIG. 8 is a sectional view of the imaging device taken along the line II-II in FIG. 7.

As shown in FIGS. 5 to 8, a recess 17 (cutout part) is formed on a leg portion 9a in the extending direction of the circuit board 3. A width of the recess 17 corresponds to the width of the circuit board 3 drawn out of the opening 12.

As shown in FIG. 7, the circuit board 3 is drawn out of the opening 12 formed by the leg portions 9, 9a through the recess 17. Unlike the case shown in FIG. 3, in this embodiment, the circuit board 3 can be removed without bending it.

As a result, it is possible to prevent the film-like circuit board 3 from being damaged due to bending, and thus improve reliability of the device.

In the drawings showing Embodiment 2, the same reference numerals as those in FIGS. 1 to 4 showing Embodiment 1 are designated to the same or like parts, and an explanation thereof is accordingly omitted.

### EMBODIMENT 3

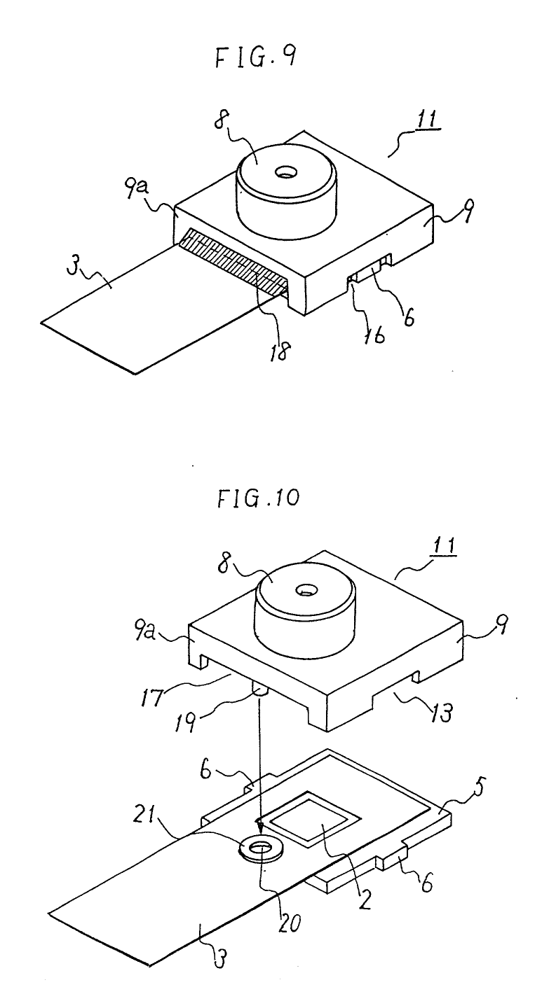

Embodiment 3 of the invention will now be described with reference to FIGS. 9 and 10.

FIG. 9 is a perspective view showing an example of an imaging device according to Embodiment 3, and FIG. 10 is an exploded perspective view showing the imaging device according to Embodiment 3. As shown in FIG. 9, a fixing mechanism 18 such as an adhesive is included for fixing the leg portion 9a to the circuit board 3 drawn out of the recess 17 (cutout part) of the leg portion 9a. The fixing mechanism 18 may be, for example, an ultraviolet curing type resin.

As shown in FIG. 10, a projection 19 is provided on the leg portion 9a and projects downward. A hole 20 is provided through the circuit board 3, and the projection 19 is inserted into the hole 20 to approximately position the circuit board 3 so the imaging element 1 and the frame 5 are integrally combined with the supporting member 11.

In other words, by inserting the projection 19 into the hole 20, the lens-barrel 8 holding the imaging lens 7 is mounted. At the same time, the supporting member 11 including the leg portion 9 and the circuit board 3 can be easily approximately positioned together.

Further, a reinforcing member 20 is mounted on the periphery of the hole 20 for the purpose of reinforcing the circuit board 3. When the circuit board 3 is a soft circuit board such as film-like circuit board, after inserting the projection 19, the reinforcing member 21 prevents the circuit board from being cut due to a stress such as an external force.

### EMBODIMENT 4

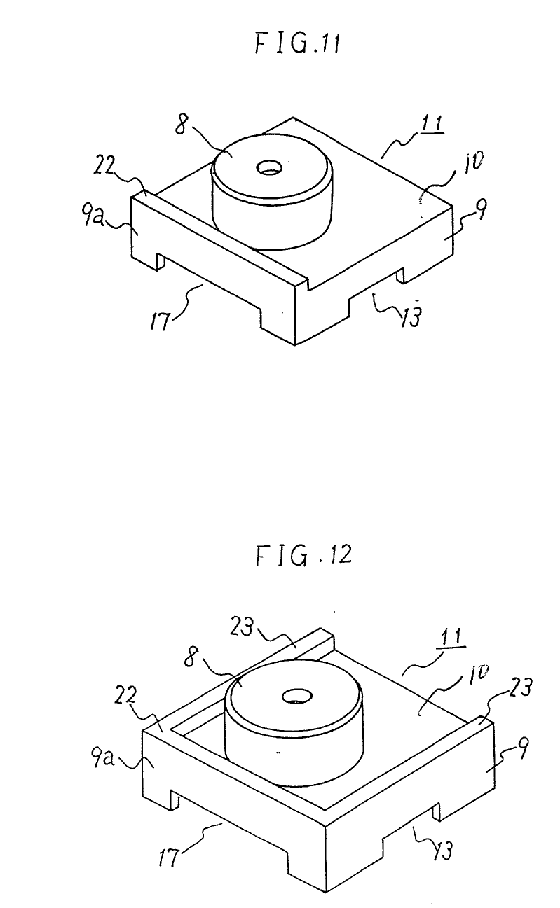

Embodiment 4 of the invention will be described with reference to FIGS. 11 and 12.

In the imaging device according to Embodiment 2, the leg portion 9 of the supporting member 11 includes the recess 13 (the first cutout part), and the leg portion 9a includes the recess 17 (the second cutout part). As a result, the supporting member 11 forming the opening 12 has a reduced structural strength due to the cutout parts formed on the leg portions 9 and 9a.

The imaging device according to Embodiment 4 is intended to improve the structural strength of the portion of the supporting member 11 where the cutout parts and the like are formed.

In more detail, FIG. 11 is a perspective view showing an example of the imaging device according to Embodiment 4, and FIG. 12 is a perspective view showing a modification of the imaging device according to Embodiment 4. As shown in FIGS. 11 and 12, a rib 22 continuously extends upward from the supporting portion 10 on the leg portion 9a, and a rib 23 continuously extends upward from the supporting portion 10 on the leg 9. The reinforcing ribs 22 and 23 reinforces the leg portions 9 and 9a.

The imaging element 1, the circuit board 3, the frame and so on are constructed in the same manner as those in the imaging devices according to the foregoing embodiments. In addition, the frame 5, the circuit board 3 and so on are not illustrated in the description of the imaging device according to this embodiment.

### EMBODIMENT 5

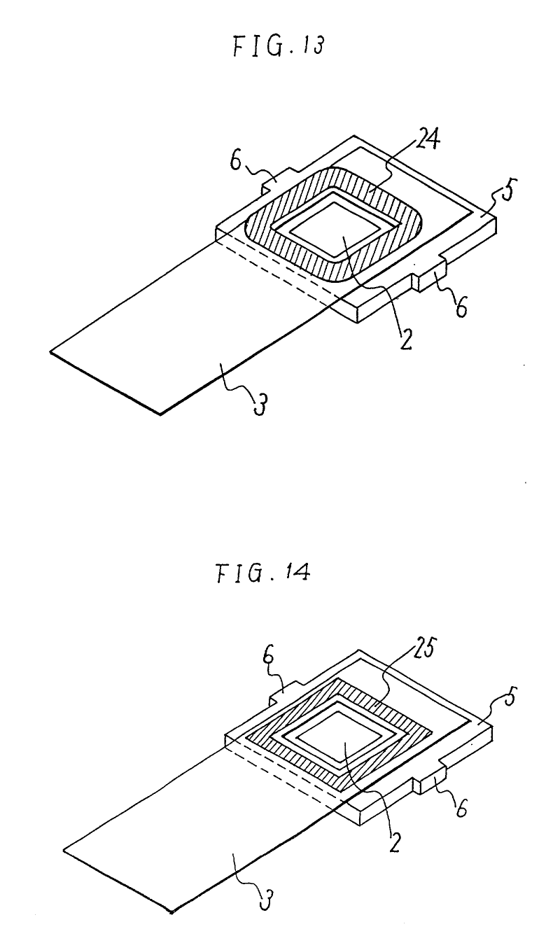

Embodiment 5 of the invention will now be described with reference to FIGS. 13 to 16. In the imaging device according to the Embodiment 3, the circuit board 3 is fixed to the leg portion 9a with the fixing mechanism 18 (e.g., an adhesive). However, because the device is small in size, this type of fixing is not always sufficient to maintain a fixed state when a strong impact is applied to the device. This embodiment is intended to firmly fix the circuit board 3 to the supporting member 11.

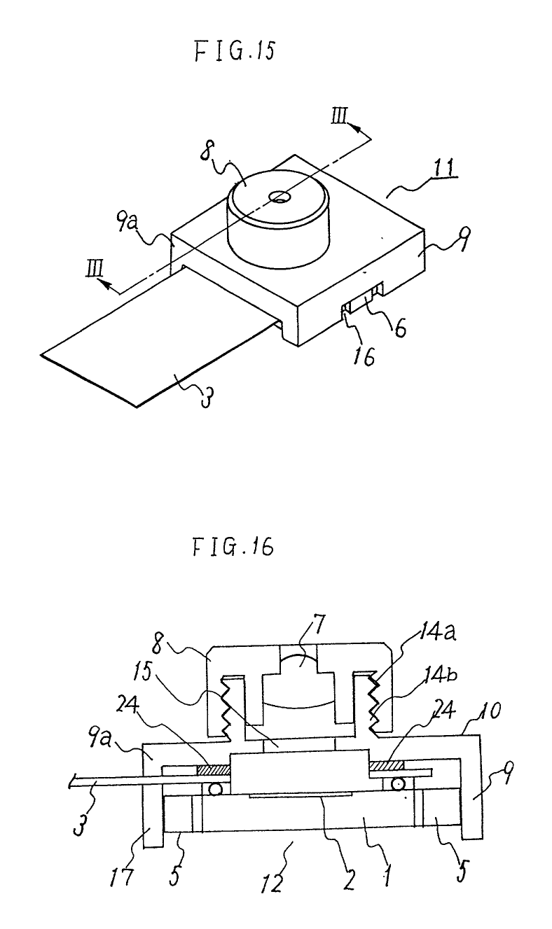

In more detail, FIGS. 13 and 14 are schematic perspective views each showing an imaging device before mounting the supporting member 11 on the circuit board 3, FIG. 15 is a perspective view showing the imaging device according to Embodiment 5 in which a line III-III is added, and FIG. 16 is a sectional view of the imaging device taken along the line III-III in FIG. 15.

As shown in FIGS. 13 to 16, fixing members 24 and 25 (adhesive) are applied to the through-hole 4 of the circuit board 3 and to a periphery of the imaging plane 2. Further, an adhesive liquid is the fixing member 24 and the fixing member 25 is a film-like adhesive fixing member. The fixing member 24 is also shown in the sectional view of the imaging device shown in FIG. 16. In the drawings, the same numerals are designated to the same or like parts, and accordingly a detailed explanation thereof is omitted.

In the imaging device according to Embodiment 5, as shown in FIGS. 13 or 14, the fixing members 24 or 25 are applied to the periphery of the through-hole 4 of the circuit board 3. Thus, the circuit board 3 is fixed to the supporting member 11 through the fixing members 24 or 25. Consequently, a wide fixed area is secured between the circuit board 3 and the supporting member 11, and the circuit board 3 is firmly fixed to the supporting member 11. As shown in FIG. 16, the circuit board 3 accommodated in the opening 12 of the supporting member 11 is fixed to the supporting member 11 with the fixing (sealing) member 24.

In this manner, it is possible to prevent the circuit board 3 from peeling off the supporting member 11 even if the imaging device is dropped or receives an external impact. Further, the imaging element 1 is securely maintained at the focal position of the imaging lens 7 where the imaging element 1 is positioned, and an imaging device of high quality with a desired reading accuracy is assured.

Next, FIG. 17 is a sectional view showing the opening 12 of the imaging device according to this embodiment sealed with a sealing member. As shown in FIG. 17, the opening 12, in which the imaging element 1, the frame 5, and the circuit board 3 are inserted, is sealed with a sealing member 26. As a result, preventing moisture from absorbing into the device is improved, and the backside of the imaging element 1 is not directly exposed. Consequently, it is possible to prevent the imaging element from being damaged by an external force or the like.

### EMBODIMENT 6

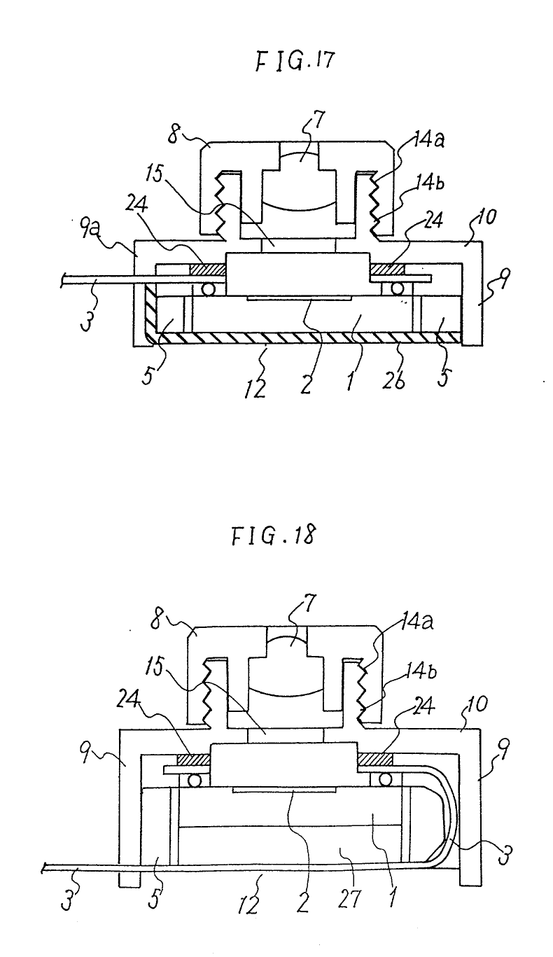

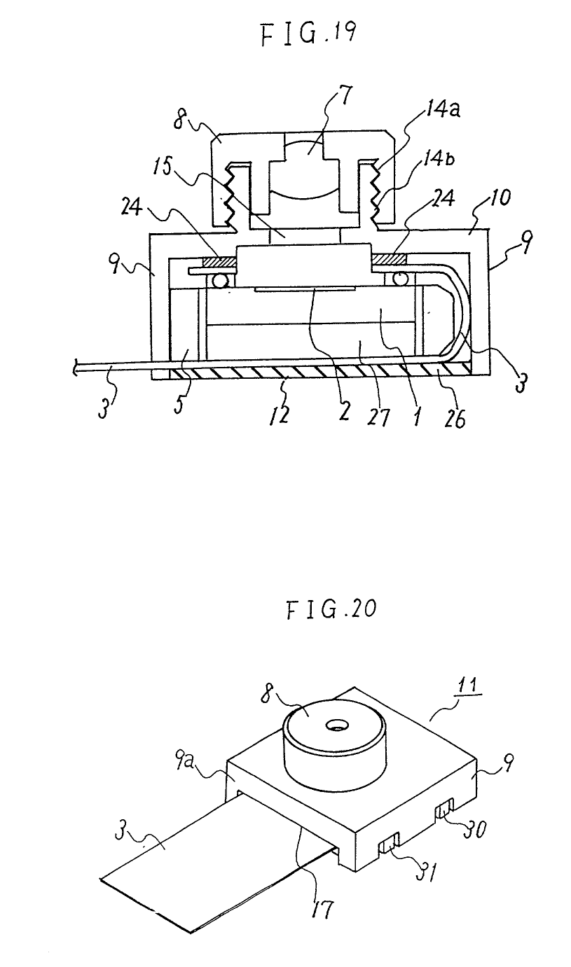

Embodiment 6 will now be described with reference to FIGS. 18 and 19. In the imaging device according to this embodiment, the circuit board 3 including the imaging element 1 and a peripheral circuit element 27 is bent in such a manner that the imaging element 1 and the peripheral circuit element may lie upon one another. Thus, the imaging element 1 and the peripheral circuit element are accommodated in the opening 12 of the supporting member 11.

The peripheral circuit element 27 is, for example, an image signal processing IC for optimizing imaging conditions based on the signal output from the imaging element 1.

FIG. 18 is a sectional view showing an imaging device according to Embodiment 6, and FIG. 19 is a sectional view showing an opening of the imaging device shown in FIG. 18 sealed with a sealing member.

As shown in FIGS. 18 and 19, the peripheral circuit element 27 and the imaging element 1 lie upon one another. Further, a film-like circuit board 3 is bent in the opening 12 of the supporting member 11 so the imaging element 1 and the peripheral circuit element 27 lie one upon another. In addition, the sealing member 26 seals the opening 12 of the supporting member 11 in which the imaging element 1, the peripheral circuit element 27, and the circuit board 3 are accommodated.

As shown in FIGS. 18 and 19, in the imaging device according to this embodiment, the circuit board 3 is bent, and the imaging element 1 and the peripheral circuit element 27 are accommodated in the opening 12 of the supporting member 11.

Accordingly, it is not necessary to arrange the elements in any region on the circuit board 3 drawn out of the opening 12 of the supporting member 11. It is also not necessary to arrange the elements separately from the imaging device on the circuit board on a body side of electronic equipment where the imaging device is mounted. As a result, it is possible to reduce the size and simplify the construction of the imaging device.

Furthermore, the opening 12 of the supporting member 11 in which the imaging element 1, the peripheral circuit element 27 and the circuit board 3 are accommodated, is sealed with the sealing member 26. As a result, it is possible to further prevent the absorption of moisture, and prevent the imaging element and the peripheral circuit element from being damaged by an external force or the like.

### EMBODIMENT 7

Embodiment 7 of the invention will now be described with reference to FIGS. 20 to 22(a) and (b).

In the imaging devices according to the foregoing embodiments, one protrusion 6 integrally formed with the frame 5 and one recess 13 of the leg portion 9 in which the protrusion is inserted and fitted are respectively provided on the opposite side of the frame 5 or the leg portion 9. On the other hand, in the imaging device according to this embodiment, plural protrusions of the frame 5 for positioning the imaging element 1 and the imaging lens 7 and plural recesses of the leg portion 9 are provided on the opposite side of the frame 5 or the leg portion 9. Furthermore, each of the plural protrusions and recesses is small in size.

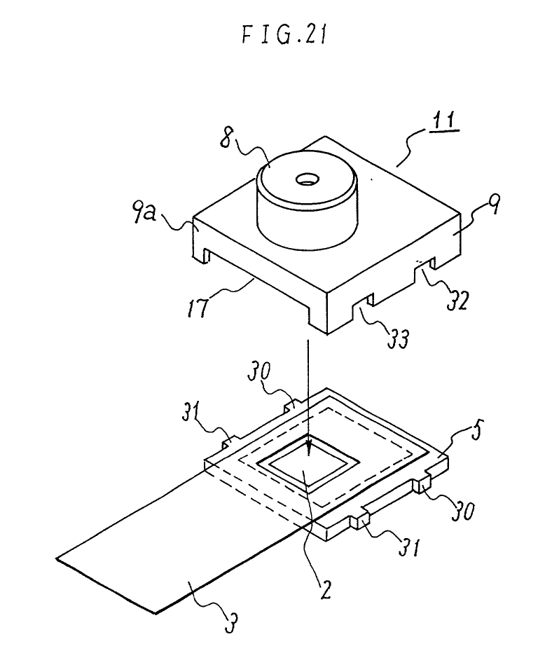

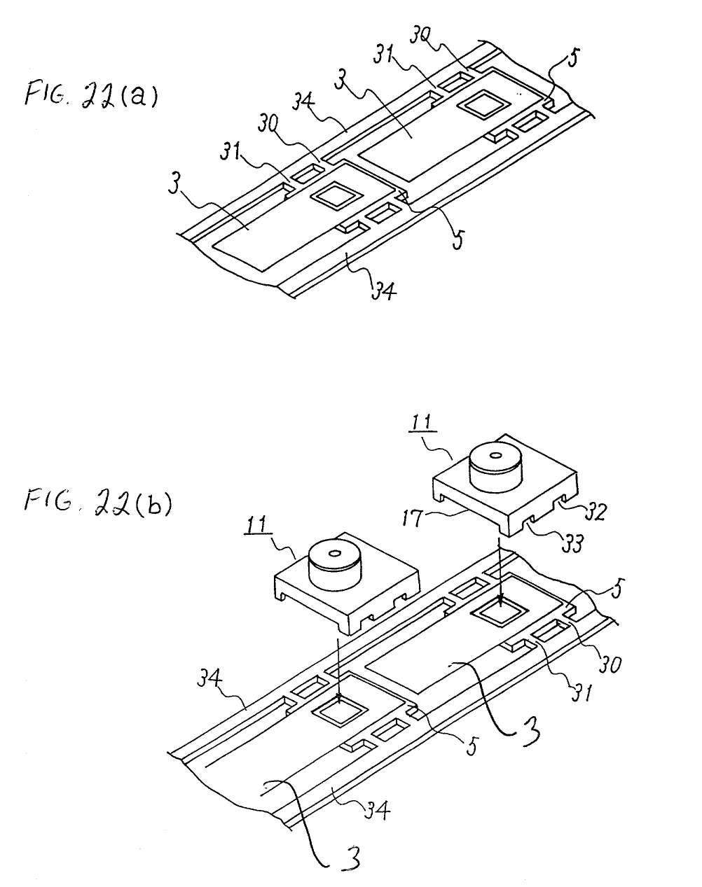

FIG. 20 is a perspective view showing the imaging device according to this embodiment, and FIG. 21 is an exploded perspective view showing the imaging device. As shown, in this embodiment, each of the opposite sides includes two protrusions and two recesses.

In more detail, as shown in FIGS. 20 and 21, protrusions 30 and 31 are integrally formed on the frame 5, and recesses 32 and 33 are formed in the leg portion 9. The protrusions 30 and 31 are inserted and fitted in the recesses 32, 33, whereby the imaging element 1 surrounded with the frame 5 and the circuit board 3 are accommodated in the opening 12 of the supporting member 11. Accordingly, it is possible to securely position the imaging plane 2 and the imaging lens 7 supported by the lens-barrel 8.

In the imaging device shown in FIGS. 20 and 21, the leg portion 9a on the side from which the circuit board 3 is drawn out includes a recess (cutout part) 17 having the same width as the circuit board 3. Note that this embodiment is also applicable to an imaging device without the recess 17 as shown in FIG. 1.

In the imaging device according to this embodiment, the frame 5 is connected with the supporting member 11 including the lens-barrel 8, the leg portion 9 and the supporting portion 10. This connection is achieved by inserting and fitting the small-sized plural protrusions 30 and 31 into the recesses 32 and 33. Consequently, it is possible to moderate and disperse the reduction in structural strength of the connected portions due to the formation of the cutout parts in the supporting member 11.

Now, a method for manufacturing the imaging device according to this embodiment will be described.

FIGS. 22(a) and (b) are perspective views illustrating steps in constructing the imaging device according to this embodiment.

As shown in FIGS. 22(a) and (b), a lead frame 34 is integrally formed with plural frames 5 through portions of the protrusions 30 and 31 of the frames 5. As described above, the frames 5 and the supporting member 11 may be produced by molding with a metallic mold and so on. The lead frame 34 having the plural frames 5 as shown in FIG. 22(a) may also be formed by molding in the same manner. In this embodiment, such a lead frame 34 is conveyed to manufacture an imaging device.

As shown in FIG. 22(b), in this embodiment, the circuit board 3 to which the imaging element 1 is fixed is placed on each frame 5 of the conveyed lead frame 34. Then, each imaging element 1 is surrounded with a respective frame 5.

In addition, the frames 5 are spaced apart from each other to prevent the circuit board 3 mounted on the frame 5 from coming into contact with a subsequent circuit board 3 and frame 5.

Then, each supporting member 11 having the imaging lens 7 is placed on the circuit board 3, and the protrusions 30 and 31 of the frame 5 are inserted and fitted in the recesses 32 and 33.

A fixing mechanism such as an adhesive is applied to the portions where the protrusions 30 and 31 are inserted and fitted in the recesses 32 and 33 when required to firmly fix the supporting members 11 to the frames 5. Thereafter, the frames 5 and the lead frame 34 are separated by disconnecting the lead frame 34 and the protrusions 30, 31, thereby obtaining the imaging devices.

As described above, in the manufacturing method according to this embodiment, the plural frames 5 and the lead frame 34 are connected and integrally formed by molding as shown in FIG. 22(a). It is therefore possible to establish dimensions of the frames 5 and a distance between one frame 5 and another with highly dimensional accuracy.

As a result, it is possible to position each of the frames 5 with ease, and plural imaging devices can be assembled easily and promptly.

Furthermore, each circuit board 3 including the imaging element 1 is correctly placed on the frame 5 without difficulty, and it is therefore possible to easily achieve automated mechanical assembling.

In the imaging device shown in FIGS. 22(a) and (b), one side of the frame 5 and the leg portion 9 includes two protrusions 30, 31 and two recesses 32, 33. The invention is not limited to such a construction as far as the frames are easily and stably disconnected from the lead frame.

### EMBODIMENT 8

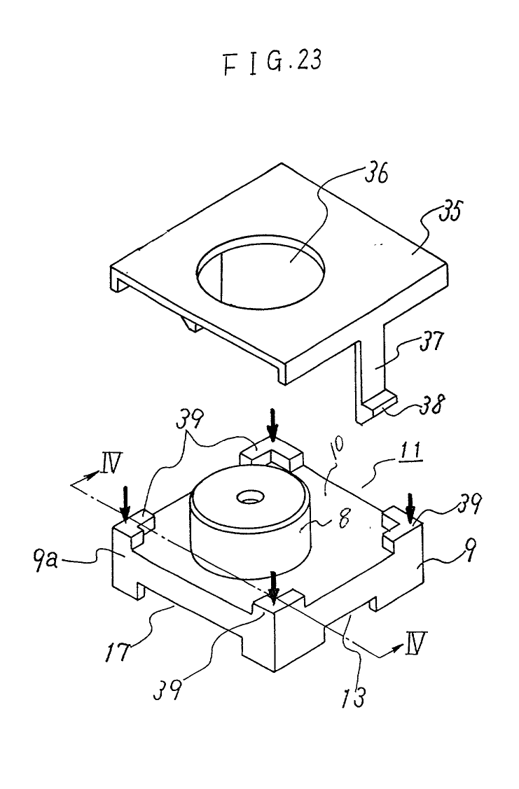

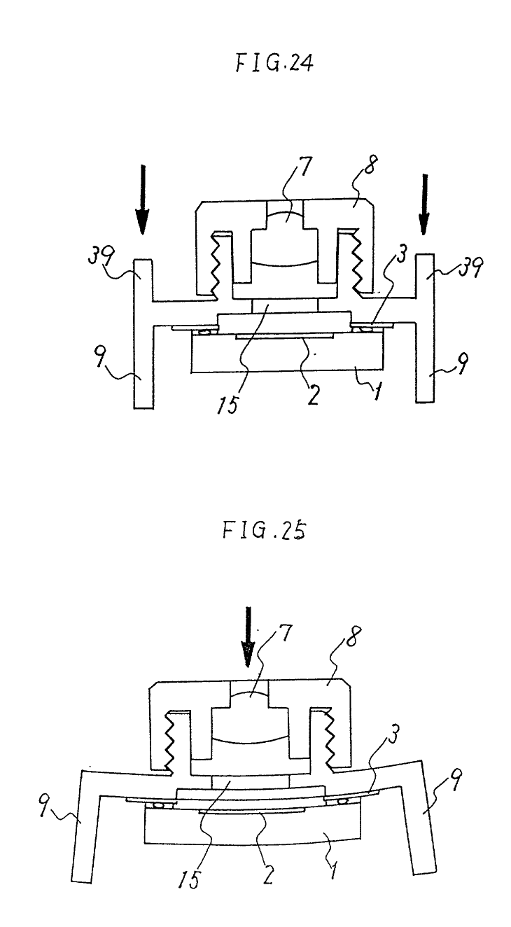

Now, Embodiment 8 of the invention will be described with reference to FIGS. 23 and 24. FIG. 23 is an exploded perspective view of the imaging device according to this embodiment in which a line IV-IV is added, and FIG. 24 is a sectional view of the imaging device taken along the line IV-IV in FIG. 23.

In FIG. 23, a holder 35 is mounted on the body of the imaging device from above the supporting member 11 supporting the lens-barrel 8. A hole 36 is provided through the holder 35 and in which the lens-barrel 8 is inserted when the holder 35 is mounted. A mounting member 27 is used when the holder 35 is mounted on the body of the imaging device. A key part 38 is also formed at the end of the mounting member 37, and a contact portion 39 formed at each corner of the support portion 10 comes in contact with the holder 35.

As shown in FIG. 23, the holder 35 includes the hole 36 through which the lens-barrel 8 is inserted, and therefore each of the contact portions 39 provided at the four corners of the support portion 10 comes in contact with the holder 35. As shown in FIG. 24, the mounting load in the direction of the arrow generated at the time of mounting the holder 35 is applied through the contact portions 39 in the extending direction of the legs portions 9 and 9a continuous from the supporting portion 10.

When the holder 35 is mounted on the body of the imaging device body after assembling the imaging device including the imaging element 1, the circuit board 3, the supporting members 11, and so on, the mounting load is uniformly applied from the lens-barrel 8. Further, as shown in FIG. 25, the structure of the supporting member 11 is deformed and a stress is generated at the portion where the imaging element 1 is in contact with the circuit board 3 in the direction of peeling the imaging element 1 off the circuit board 3. Generation of such stress causes the imaging element 1 to peel off the circuit board 3 and causes problems.

In the imaging device according to this embodiment, however, the load when mounting the holder 35 is not uniformly applied from the lens-barrel 8, but is applied through the contact portions 39 to the corners of the supporting portion 10 and the legs portions 9 and 9a. Therefore, in spite of mounting the holder 35, the connecting portion between the imaging element 1 and the circuit board 3 is prevented from generated stress caused by the mounting load. As a result, it is possible to obtain an imaging device of high quality without problems occurring in the device after assembling the imaging element 1, the circuit board 3, the supporting member 11, and so on into the device.

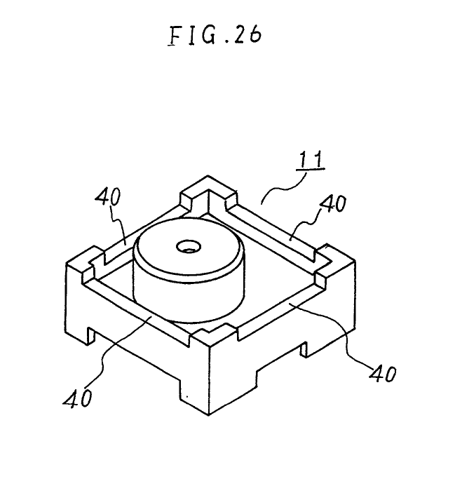

It is also preferable to provide a reinforcement member such as rib between one contact portion 39 and another formed at the comers of the supporting portion 10 for connection between one contact portion 39 and another with the reinforcement member. FIG. 26 is a perspective view showing the imaging device according to this embodiment provided with such reinforcement members.

In FIG. 26, a rib 40 is formed continuous from the supporting portion 10 and extends upward from the legs 9 or 9a. The rib 40 is a reinforcement member for connecting the contact portions 39 formed at the comers of the supporting portion 10 with each other.

In the drawings, the same reference numerals indicate the same or like parts, and a further detailed explanation of them is omitted herein. As shown in FIG. 26, the structure of the supporting member 11 is reinforced as a result of providing the reinforcement members 40 for connecting between one contact portions 39 and another. Consequently, it is possible to prevent generation of stress caused by the mounting load of the holder 35 as described above, and it is possible to obtain an imaging device of high quality.

Obviously, numerous modifications and variations of the present invention are possible in light of the above teachings. It is therefore to be understood that within the scope of the appended claims, the invention may be practiced otherwise than as specifically described herein.

1. An imaging device comprising:
an imaging element having a light acceptance plane;
a frame surrounding a marginal portion of said imaging element so as to fix said imaging element;
an image formation lens configured to form an image on said light acceptance plane;
a lens-barrel configured to support said image formation lens; and
a supporting member on which said lens-barrel is mounted and including leg portions forming an opening for accommodating said frame and said imaging element,
wherein an outside of said frame includes protrusions, and the leg portions of said supporting member include mount portions configured to integrally mount said protrusions.

2. The imaging device according to claim 1, further comprising:
a through-hole configured to expose the light acceptance plane of the imaging element and a film-like circuit board formed with a wiring pattern,
wherein said film-like circuit board is drawn out of the opening.

3. The imaging device according to claim 1, wherein the protrusions are provided at opposite portions of the frame, and the mount portions are provided at opposite portions of the leg portions corresponding to said protrusions.

4. The imaging device according to claim 1, wherein the mount portions comprise cutout parts onto which the protrusions are fixed with an adhesive.

5. The imaging device according to claim 1, further comprising:
an adjusting mechanism configured to adjust a position of the lens-barrel holding the image formation lens with respect to the light acceptance plane of the imaging element.

6. The imaging device according to claim 2, wherein the leg portions include a second cutout part in a direction extending the film-like circuit board, and the film-like circuit board is drawn out of said second cutout part without bending.

7. The imaging device according to claim 6, wherein the film-like circuit board is fixed to the leg portions with an adhesive at the second cutout part.

8. The imaging device according to claim 6, further comprising:
a projection projecting toward the film-like circuit board in the second cutout part of the leg portions, and a hole provided on said film-like circuit board and in which said projection is inserted.

9. The imaging device according to claim 8, further comprising:
a reinforcing member mounted on a periphery of the through-hole of the film-like circuit board.

10. The imaging device according to claim 2, wherein an adhesive is applied to a periphery of the through-hole of the film-like circuit board, and said film-like circuit board is fixed to the supporting member forming the leg portions with said adhesive.

11. The imaging device according to claim 1, wherein the leg portions include integrally formed ribs extending toward the lens-barrel.

12. The imaging device according to claim 2, wherein said film-like circuit board is bent in the opening, a peripheral circuit element mounted on said film-like circuit board is arranged facing an opposite side of the light acceptance plane of the imaging element, and said peripheral circuit element is accommodated in said opening.

13. The imaging device according to claim 12, wherein the opening is sealed with a sealing member.

14. The imaging device according to claim 1, wherein portions coming into contact with a holder serving as fixing mechanism when the imaging device is mounted on an electronic equipment are located at four comers of the supporting member.

15. An imaging system comprising:
an imaging element having a light acceptance plane;
frame means surrounding a marginal portion of said imaging element and for fixing said imaging element;
image formation means for forming an image on said light acceptance plane;
lens-barrel means for supporting said image formation means; and
supporting means on which said lens-barrel means is mounted and including means for accommodating said frame and said imaging element,
wherein an outside of said frame means includes protrusions, and said supporting means include mount means for integrally mounting said protrusions.

16. The imaging system according to claim 15, further comprising:
through-hole means for exposing the light acceptance plane of the imaging element and a film-like circuit board formed with a wiring pattern,
wherein said film-like circuit board is drawn out of the opening.

17. The imaging system according to claim 15, wherein the protrusions are provided at opposite portions of the frame means, and the mount means are provided at opposite portions of the accommodating means corresponding to said protrusions.

18. The imaging system according to claim 15, wherein the mount means comprise cutout parts onto which the protrusions are fixed with an adhesive.

19. The imaging system according to claim 15, further comprising:
adjusting means for adjusting a position of the lens-barrel means holding the image formation means with respect to the light acceptance plane of the imaging element.

20. The imaging system according to claim 16, wherein the accommodating means include a second cutout part in a direction of extending the film-like circuit board and said film-like circuit board is drawn out of said second cutout part without bending.
